(19) United States
(12) Patent Application Publication
(10) Pub. No.: US 2011/0109062 A1
(43) Pub. Date: May 12, 2011

(54) TOW LINE/STRAP ASSEMBLY

(76) Inventors: Charles Kenneth Fincher, Fredericksburg, VA (US); Kirk Bradley, Fayetteville, GA (US)

(21) Appl. No.: 12/940,640

(22) Filed: Nov. 5, 2010

Related U.S. Application Data
(60) Provisional application No. 61/258,782, filed on Nov. 6, 2009.

(51) Int. Cl. B60D 1/18

(52) U.S. Cl. 280/480

(57) ABSTRACT

A line and/or strap assembly allowing for offset towing configurations is disclosed. The assembly permits off-center towing.

### CROSS REFERENCE TO RELATED APPLICATIONS

This application claims the benefit of U.S. Provisional Application Ser. No. 61258782 filed on Nov. 6, 2009 and entitled Tow line/Strap Assembly, which is incorporated in its entirety herein by reference.

### BACKGROUND OF THE INVENTION

1. Field of the Invention

The present invention relates to line and/or strap assemblies used for towing vehicles and the like. More particularly, to a line and/or strap assembly allowing for offset towing configurations.

2. Description of the Related Art

Three point towing line and/or strap (hereinafter referred to either as “line”) assemblies currently known in the art require the pulling vehicle to be substantially centered between the two attachment points of the line to the towed vehicle. In situations where this is not readily possible, towing lines known in the art do not provide optimal transfer of towing forces from the towing vehicle to the towed vehicle.

With these considerations in mind, it is desirable to have solutions of new invention.

### SUMMARY OF THE INVENTION

The subject invention is directed to a new towing line assembly that permits off-center towing. According to one aspect of the invention, an attachment device comprises a first line having a first loop at one end of the first line and a trolley at the other end of the first line. The attachment device further has a second line having a loop at both ends thereof and extending through the trolley.

According to another aspect of the invention, a towing device is disclosed which comprises a first eyelet bar having a U-shaped element, a fixed axle (also called a pin), and a rotatable element positioned on the pin for rotating thereabout. The device also comprises a first line having a first eyelet at a first end of the first line and a second eyelet at a second end of the first line, wherein the second eyelet is connected to the U-shaped element. A second line extends through the shackle and bears upon the rotatable element. The second line has a first eyelet at a first end of the second line and a second eyelet at a second end of the second line. A first shackle is connected to the first eyelet of the second line and a second shackle is connected to the second eyelet of the second line.

As will be appreciated by those persons skilled in the art, a major advantage provided by the present invention is an attachment device that overcomes the aforementioned shortcomings of prior devices. Additional objects of the present invention will become apparent from the following description.

### BRIEF DESCRIPTION OF THE DRAWINGS

So that those having ordinary skill in the art to which the subject invention pertains will more readily understand how to make and use the subject invention, preferred embodiments thereof will be described in detail herein with reference to the drawings.

FIG. 1 is an isometric view of a preferred embodiment of the present invention.

FIG. 2 is an isometric view of a preferred embodiment of the present invention.

FIG. 3 is an exploded view of a preferred embodiment of the present invention.

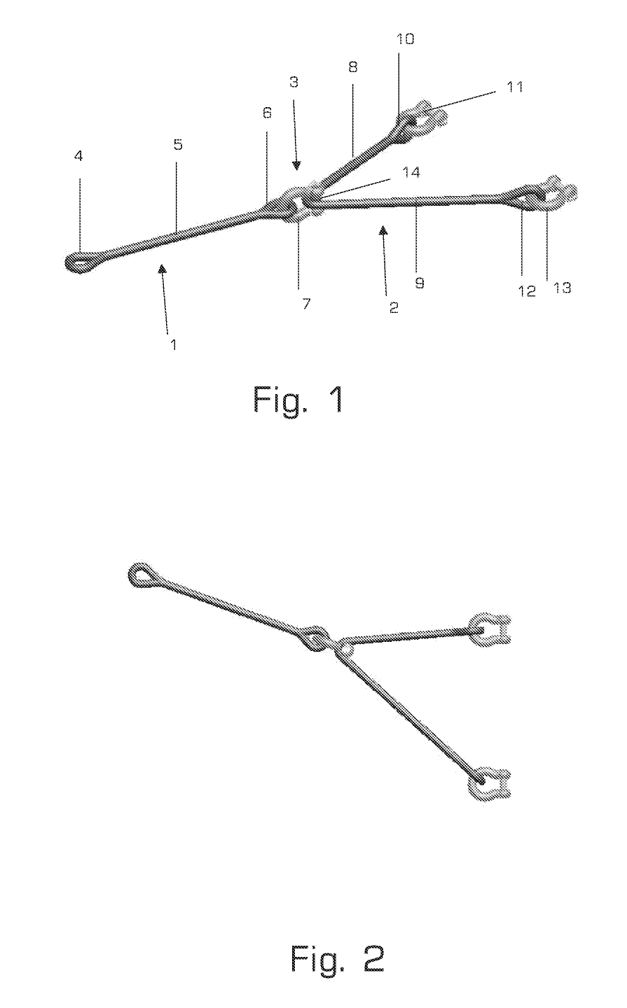

The method and apparatus of the present invention will be better understood by reference to the following detailed discussion of specific embodiments and the attached figures which illustrate and exemplify such embodiments.

### DESCRIPTION OF THE PREFERRED EMBODIMENT

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The figures disclosed herein are drawn to scale for the preferred embodiments they depict.

Towing line assembly includes a line 1 which is to be attached to a pulling force and a line 2 which is attached to an element to be pulled. Lines 1 and 2 are preferably straps. The lines may be of single or multi-strand fibers. If multi-strand, they may be braided, woven or wrapped.

Pulling line 1 includes a distal loop or eyelet 4 at a distal end and a central loop or eyelet 6 at center portion 3. line 5 extends between distal loop 4 and central loop 6. Central loop 6 is secured to trolley 7.

Pulled line 2 includes a left portion 8 and a right portion 9. Left portion 8 includes a distal loop or eyelet 10. Distal loop 10 is secured to pulling shackle 11. Right portion 9 includes a distal loop or eyelet 12. Distal loop 12 is secured to pulling shackle 13.

Pulled line 2 is threaded through the eye of trolley 7 so that it is free to move along axle 14. Preferably, axle14 may further have a rotating element thereon upon which line 2 bears. Use of such a rotating element serves to reduce friction between the line 2 and the axle 14. In this way, the trolley acts as a load equalizer through which line 2 extends. Of course, any similarly functioning type of shackle may also be used in place of the trolley.

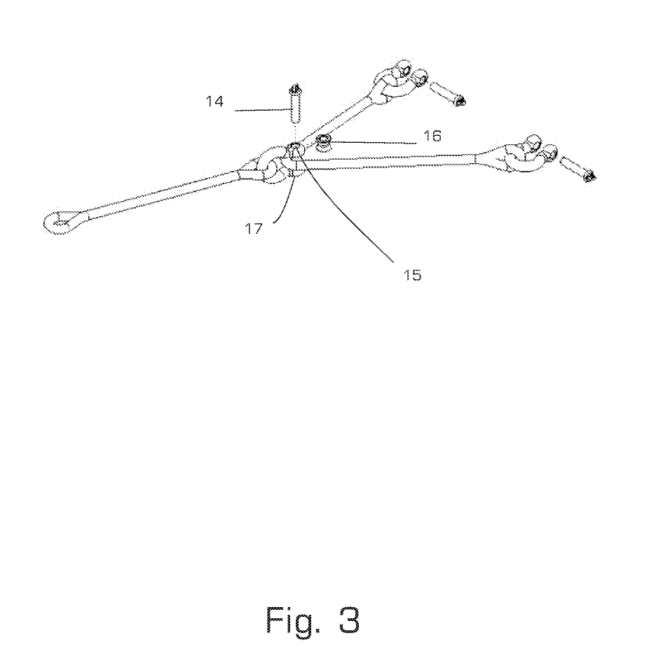

As shown in FIG. 3, axle 14 is fed through eyelet 15. Sleeve bearing 16 is placed about axle 14 so as to be positioned between eyelets 15 and 17.

When loop 4 is affixed to a towing vehicle and pulling shackles 11 and 13 are attached to a towed vehicle, tension remains effectively constant on portions 8 and 9 regardless of towing angle. As seen in FIG. 2, when the towing angle changes, the lengths of portions 8 and 9 are automatically adjusted as pulled line 2 slides along central portion 3, thereby maintaining tension on both portions 8 and 9.

Although the particular embodiments shown and described above will prove to be useful in many applications in the towing and the hauling arts to which the present invention pertains, further modifications of the present invention will occur to persons skilled in the art. All such modifications are deemed to be within the scope and spirit of the present invention as defined by the appended claims.

What is claimed is:

1. An attachment device, comprising;
a. a first line having a first loop at one end of the first line and a trolley at the other end of the first line; and
b. a second line having a loop at both ends thereof and extending through the trolley.

2. The attachment device of claim 1, further comprising a second loop at the other end of the first line, wherein the trolley is attached to the second loop.

3. The attachment device of claim 2, wherein the trolley is fixed to the second loop.

4. The attachment device of claim 3, wherein the trolley comprises a U-shaped element and an axle fixed therethrough, wherein the axle has a rotating element thereon.

5. The attachment device of claim 4, wherein the loops of the second line each have an attaching element connected thereto.

6. The attachment device of claim 5, wherein the first line and the second line comprise one of braided, woven or wrapped lines.

7. The attachment device of claim 6, wherein the first line and the second line are cables or straps.

8. The attachment device of claim 7, wherein the cables or straps are multistranded.

9. The attachment device of claim 8, wherein the attaching elements are removable.

10. The attachment device of claim 9, wherein the attaching elements are shackles, and wherein each shackle has a removable pin.

11. An attachment device, comprising:
a. a first line having a loop both ends thereof;
b. a trolley attached to one of the loops of the first line;
c. a second line having a loop at both ends thereof and extending through the trolley.

12. The attachment device of claim 11, further wherein the trolley is fixed to the loop of the first line.

13. The attachment device of claim 12, wherein the trolley comprises a U-shaped element and an axle fixed therethrough, wherein the axle has a rotating element thereon.

14. The attachment device of claim 13, wherein each of the loops of the second line have an attaching element connected thereto.

15. The attachment device of claim 14, wherein the first line and the second line comprise one of braided, woven or wrapped lines.

16. The attachment device of claim 15, wherein the first line and the second line are cables or straps.

17. The attachment device of claim 16, wherein the cables or straps are multistranded.

18. The attachment device of claim 17, wherein the attaching elements are removable.

19. The attachment device of claim 18, wherein the attaching elements are shackles, and wherein each shackle has a removable pin.

20. A towing device, comprising:
a. a first eyelet bar having a U-shaped element, a fixed axle, and a rotatable element positioned on the axle for rotating thereabout;
b. a first line having a first eyelet at a first end of the first line and a second eyelet at a second end of the first line, wherein the second eyelet is connected to the U-shaped element;
c. a second line extending through the trolley and bearing upon the rotatable element, wherein the second line has a first eyelet at a first end of the second line and a second eyelet at a second end of the second line;
d. a second shackle connected to the first eyelet of the second line; and
e. a third shackle connected to the second eyelet of the second line.
